(19) United States
(12) Patent Application Publication
(10) Pub. No.: US 2012/0209685 A1
(43) Pub. Date: Aug. 16, 2012

(54) CHECK-INS TO COMMERCIAL VENUES

(75) Inventors: Bryan Welbourne Nealer, Seattle, WA (US); Megan Lesley Tedesco, Sammamish, WA (US)

(73) Assignee: MICROSOFT CORPORATION, Redmond, WA (US)

(21) Appl. No.: 13/027,807

(22) Filed: Feb. 15, 2011

(51) Int. Cl. G06Q 30/00

(52) U.S. Cl. 705/14.25; 705/14.36

(57) ABSTRACT

A system and method are provided for a user to check-in to one or more commercial venues according to various check-in options including private, public, anonymous, and non-anonymous check-ins, and for merchants to provide one or more targeted offers to the user based on contextual data associated with the user. In one embodiment, one or more queries may be generated for the user to select at least one of a pubic check-in option, a private check-in option, an anonymous check-in option, a non-anonymous check-in option, or a combination thereof. The system may be configured to determine one or more offers configured for a merchant to be provided to the user based on the contextual data associated with the user.

### BACKGROUND

Social networks that track and enable connections between members (including people, businesses, and other entities) have become prevalent in recent years. Foursquare is a location-based social network website that allows registered users to check-in at venues using a mobile website, text messaging, or a device-specific application. Users who check-in to a venue are then awarded points for checking-in at the venue. Users may also choose to have their check-ins posted on their accounts on Twitter, Facebook, or other similar social network websites.

Shopkick is a mobile application that gives a customer rewards and other offers for simply walking into stores. For example, the Shopkick application listens for a “Shopkick signal” emitted from speakers inside a store which is inaudible to human ears.

However, check-ins to commercial venues via social networks present several problems. One notable problem is that some users may be discouraged from checking-in to commercial venues via social networks because they do not wish to have their locations broadcasted to their social graphs, while others may be reluctant to provide information associated with them to the commercial venues when they check-in. Yet the users want to take advantage of the benefits offered by commercial venues by checking-in to the commercial venues without providing the contextual information associated the users and/or broadcasting their locations to their social graphs.

Although Foursquare allows a user to “privately” check-in to commercial venues without announcing the user's locations to his social graph, such private check-ins are not strictly anonymous. For example, a user may become the ‘mayor’ of a particular location when he visits the location the most. But when the user becomes a “mayor” of that particular location, information about his location will be publicly available to all other Foursquare users, thereby destroying the user's anonymity.

Another problem associated with check-ins via social networks such as Foursquare is that these third-party check-in applications provided by the social networks do not have access to the contextual data associated with the users. For example, the contextual data associated with a user may include information related to the user's location history, his past shopping history, his friends, and other relevant information associated with the user. The contextual data associated with a user may be used by merchants to provide targeted offers (e.g., coupons, loyalty programs, product sales, and other location-based marketplace offers) to the user when he checks-in with the merchants. Therefore, the more contextual data associated with a user, the more targeted offers may be provided by merchants to the user.

### SUMMARY

A system and method for a user to check-in to one or more commercial venues according to various check-in options including private, public, anonymous, and non-anonymous, and for merchants to provide one or more targeted offers to the user based on contextual data associated with the user. In one embodiment, one or more queries may be generated for the user to select at least one of a pubic check-in option, a private check-in option, an anonymous check-in option, a non-anonymous check-in option, or a combination thereof. The system is configured to determine one or more offers configured for a merchant to be provided to the user based on the contextual data associated with the user.

According to one embodiment, techniques are provided for providing an offer associated with a commercial venue to a user. A request associated with the user is received. The request identifies a commercial venue for the user to check-in and a set of one or more check-in options for the user to check-in to the commercial venue. An offer associated with the commercial venue identified in the request is determined to be provided to the user based upon a set of contextual data associated with the user if any. Determining the offer to be provided to the user includes determining a set of one or more offers configured for the commercial venue and determining that a condition associated with a particular offer from the set of one or more offers configured for the commercial venue is satisfied by the contextual data associated with the user, wherein the particular offer from the set of one or more offers configured for the commercial venue is the offer determined to be provided to the user. Each offer configured for the commercial venue having a condition associated with the offer configured for the commercial venue. A response message including the offer determined to be provided to the user may be generated and returned to the user.

One embodiment receives a configuration request associated with a merchant. A set of one or more offers associated with the merchant may be generated in response to the configuration request. Each offer generated may have a condition associated with the offer. A check-in request associated with a user may be received. The check-in request identifies a commercial venue associated with the merchant and a set of one or more check-in options. The one or more check-in options may be selected by the user in response to one or more queries. At least one offer from the set of one or more offers associated with the merchant may be provided to the user based upon a set of contextual data associated with the user.

One embodiment receives information identifying one or more locations associated with the user. The one or more locations include a current location of the user and a list of one or more commercial venues within close proximity to the current location of the user. One or more queries for asking the user to check-in to the one or more commercial venues may be generated responsive to the information received. A request associated with the user is received. The request identifies a commercial venue from the list of one or more commercial venues for the user to check-in and a set of one or more check-in options for the user to check-in to the commercial venue. An offer associated with the commercial venue identified in the request is provided to the user based upon a set of contextual data associated with the user.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 a block diagram of an embodiment of a check-in system.

FIG. 2 is an example of a mobile computing device for implementing the present technology.

FIG. 3 is an example of a computing device for implementing the present technology.

FIG. 4 is a simplified flow chart of a process for a user to check-in to one or more commercial venues according to an embodiment of the present technology.

FIG. 5 is a simplified flow chart of a process for querying a user to check-in to one or more commercial venues according to an embodiment of the present technology.

FIGS. 6A and 6B are simplified flow charts of a process for processing a check-in request associated with a user and for proving one or more offers to the user according to an embodiment of the present technology.

FIG. 7 is a simplified flow chart of a process for a merchant to access one or more services provided to the merchant by merchant platform 180 of FIG. 1 according to an embodiment of the present technology.

FIG. 8 is a simplified flow chart of a process for configuring one or more offers associated with a merchant according to an embodiment of the present technology.

FIG. 9 is an example of a user interface for a user to check-in to one or more commercial venues.

### DETAILED DESCRIPTION

A system and method for a user to check-in to one or more commercial venues according to various check-in options including private, public, anonymous, and non-anonymous check-ins, and for merchants to provide one or more targeted offers to the user based on contextual data associated with the user. In one embodiment, one or more queries may be generated for the user to select at least one of a pubic check-in option, a private check-in option, an anonymous check-in option, a non-anonymous check-in option, or a combination thereof. The system is configured to determine one or more offers configured for a merchant to be provided to the user based on the contextual data associated with the user.

By providing one or more check-in options for a user to check-in to a commercial venue, the user is able to choose how the user checks-in to the commercial venue. For example, a user may be able to take advantage of the benefits provided by a merchant via anonymous and/or private check-ins to one or more commercial venues associated with the merchant. Further, when a user checks-in to a commercial venue non-anonymously, a merchant is able to provide one or more target offers configured for the merchant to the user based on the contextual data associated with the user.

The present technology may be applied towards a mobile phone device, mobile computing device or other type of computing device.

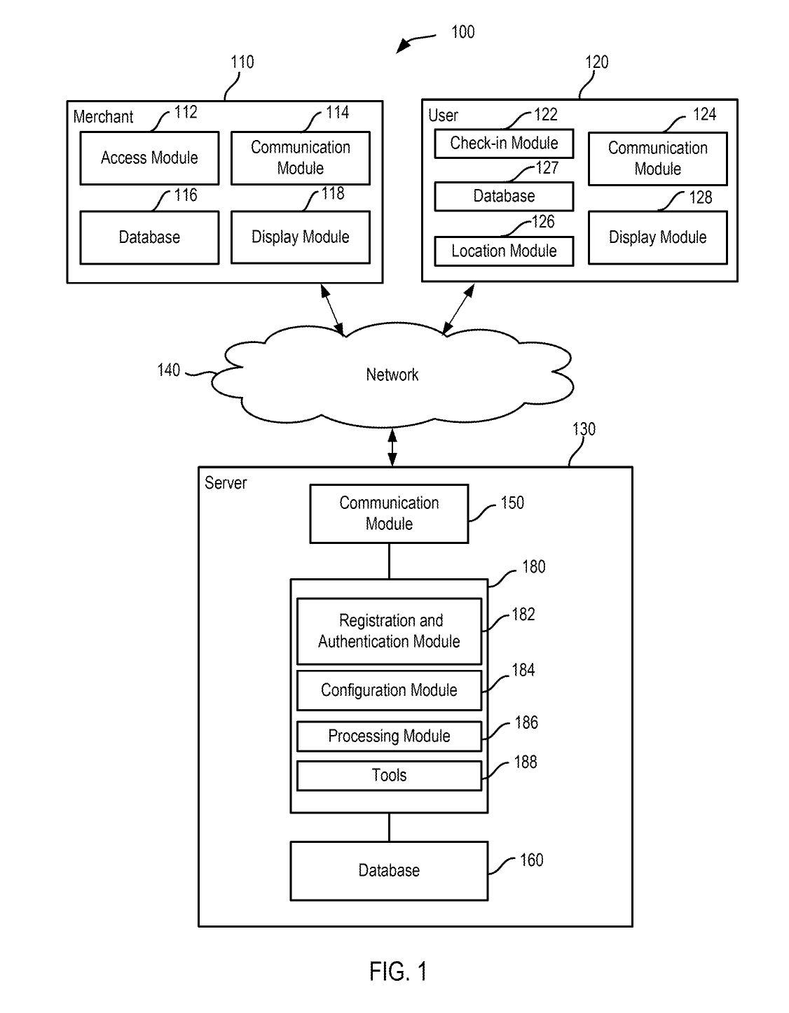

FIG. 1 illustrates a block diagram of an embodiment of a system 100 for users to check-in to commercial venues and for merchants to provide targeted offers to users based on contextual data associated with the users. Throughout this document, “users” refer to anyone who may check-in to one or more commercial venues to receive offers and discounts from merchants, or just to announce his/her location to the “social graph” (The term “social graph” was originally referred to the social network of relationships between users of the social networking service, and has been expanded to refer to a social graph of all Internet users). “Merchants” refer to any business entity that conducts business at one or more commercial venues including one or more “brick-and-mortar” stores. “Merchants” and “commercial venues” may be used interchangeably throughout the document. Contextual data associated with a user may include information related to the user's location history, information about the user's past shopping history, information identifying the user's friends, demographic information and other information associated with the user. Contextual data may be obtained from the information that is collected and stored by a user device such as cellular telephone or other mobile computing device. While the term “query” may be used in the document, it is understood that query should be construed broadly to include any type of messages.

System 100 of FIG. 1 may include a merchant system 110 that is configured for a merchant to access various services and resources provided by other components and systems in system 100 such as services provided by server 130, a user system 120 that is configured for a user to check-in to one or more commercial venues and to select one or more check-in options for checking-in to the one or more commercial venues, and a server 130 that is configured to provide various services and resources for users and merchants related to check-in to commercial venues. For example, server 130 may include services and resources for a user to check-in to one or more commercial venues via user system 120 according to one or more check-in options and other information provided by the user, and may further include services and resources for a merchant to configure one or more offers to be returned to a user based on contextual data associated with the user.

System 100 of FIG. 1 may further include a network 140. Networks 140 may be implemented as the Internet or other WAN, a LAN, intranet, extranet, private network or other network or networks. The various components and modules depicted in system 100 of FIG. 1 are merely examples of components that may be included in system 100. In alternate embodiments, system 100 may have less or more components than those shown. The modules and components in system 100 may be implemented in software (e.g., code, program, instructions that are stored on a machine-readable medium and executed by a processor), hardware, or combinations thereof.

As depicted in FIG. 1, merchant system 110 is a computing system that may include access module 112, communication module 114, database module 116, display module 118, and other modules and/or components. Although it is not shown in FIG. 1, merchant system 110 may include any suitable device that may be used by a merchant to access various services provided by merchant platform 180 (discussed below). For example, merchant system 110 may be a computer, a laptop computer, a mobile computing device, a smart phone, or other devices. The modules and components in merchant system 110 may be implemented in software (e.g., code, program, instructions that are stored on a machine-readable medium and executed by a processor), hardware, or combinations thereof.

Access module 112 of merchant system 110 may be configured to allow a merchant to access various resources and services provided by server 130 including merchant platform 180 via merchant system 110. For example, a merchant may access configuration module 184 (discussed below) of merchant platform 180 for configuring one or more offers associated with the merchant. The one or more offers configured for the merchant may be provided to a user based on the contextual data associated with the user. Configuring one or more offers associated with a merchant is discussed below in further details.

In one embodiment, access module 112 may be implemented as a web browser to provide an interface for a merchant to access the various services and resources provided by server 130. For example, a merchant may access a service home page for merchant platform 180 by entering a URL address for the home page (e.g., www.merchantplatform.com). In response to the URL entered, the web browser implemented in access module 112 requests the desired web page from server 130. The requested web page may be displayed by display module 118 in an interface such as a graphical user interface (GUI). As a result, the merchant may use the various services and/or resources provided by merchant platform 180 such as configuring one or more target offers using the configuration services provided by merchant platform 180 (discussed below).

Communication module 114 may be configured to enable communication between merchant system 110 and other systems or sub-systems in system 100. For example, a merchant may send information associated with the merchant to registration and authentication module 182 of merchant platform 180 for registering with merchant platform 180 via communication module 114. Registering a merchant with merchant platform 180 is discussed below in further details. In another example, a merchant may receive information stored in database 160 via communication module 114.

Database module 116 of merchant system 110 may be implemented as one or more databases that retrieve (extract) data from other data stores such as database 160 of server 130, perform calculations on the retrieved data to generate and aggregate metric data, provide data to display module 118 for display, and perform other business logic. In one embodiment, database module 116 may collect and store various data associated with a merchant. For example, database module 116 collects and stores a list of one or more offers configured for a merchant by configuration module 184 of merchant platform 180 and the corresponding conditions associated with the one or more offers configured for the merchant.

Display module 118 may display various data associated with a merchant. In one embodiment, display module 118 receives a list of one or more offers configured for the merchant as well as other information such as display preferences stored in database modules 116, and displays the received data and information in an interface (e.g., GUI).

Merchant system 110 may also include other modules and components for implementing the present technology. In some embodiments, merchant system 110 may include an export module (not shown in FIG. 1) that is configured to export data or other relevant information to external devices such as an USB device, a printer, an external hard drive, and the like. The data and other relevant information that may be exported may include a list of target offers configured for a merchant by merchant platform 180, the success rate associated with these offers (e.g., how many offers configured for this merchant have been successfully provided to users in the past 30 days?), information stored in databases 160, etc.

As depicted in FIG. 1, user system 120 may include a check-in module 122, a communication module 124 that is configured to enable communications between user system 120 and other systems or sub-systems in system 100, a location module 126, a database module 127, a display module 128, and other modules and components. Although it is not shown in FIG. 1, user system 120 may include any suitable device that may be used by a user to check-in to one or more commercial venues, receive one or more offers associated with a merchant and other information associated with the merchant. For example, a user device may be a computer, a laptop computer, a mobile phone, or other suitable computing devices available to the user. The modules and components in user system 120 may be implemented in software (e.g., code, program, instructions that are stored on a machine-readable medium and executed by a processor), hardware, or combinations thereof.

Location module 126 is configured to receive one or more signals containing information that identifies (or helps to identify) one or more locations associated with a user. In one embodiment, location module 126 is configured to receive a Global Positioning System (“GPS”) signal broadcasted from a GPS system. A GPS signal received by location module 126 may include information indicating a current geographic location (e.g. street address) of the user. For example, a GPS signal may be received into location module 126 of user system 120 that indicates 123 Main Street, College Town, California 90210 is a current geographic location for the user. Alternatively, a GPS signal received in location module 126 may include information indicating a list of one or more commercial venues near the user's current geographical location. For example, a GPS signal received in location module 126 of user system 120 may indicate a first store located at 1.5 miles from the user's current location, a second store located at 2.3 miles from the user's current location, and other stores within a three-mile radius from the user's current location. In yet another example, a GPS signal received in location module 126 may include information indicating both a current address of a user and a list of one or more commercial venues within close proximity to the user's current location.

In some embodiments, location module 126 is configured to receive one or more signals emitted from one or more commercial venues. The one or more signals received by location module 126 may include information identifying a list of one or more commercial venues within close proximity to the user's current location. For example, when a user is within close proximity to a commercial venue (e.g., within a 0.25-mile radius), location module 126 of user system 120 may receive one or more signals emitted from a speaker device installed in the commercial venue that are inaudible to human ears. In one embodiment, location module 126 may implement the Bluetooth technology for sensing signals emitted from commercial venues. In one embodiment, the one or more signals received in location module 126 are communicated to check-in module 122.

In one embodiment, based on the information included in the one or more signals received from location module 126, check-in module 122 is configured to generate one or more queries for querying a user of user system 120 if the user would like to check-in to the one or more commercial venues indicated in the one or more signals (if any), and how the user would like to check-in to the one or more commercial venues.

In one embodiment, check-in module 122 is configured to generate a query for asking a user to indicate which commercial venue(s) from a list of commercial venues that the user would like to check-in. For example, assuming that there are a list of five commercial venues indicated in the signals communicated from location module 126 to check-in module 122, then a query may be generated by check-in module 122 for querying a user of user system 120 which commercial venue(s) from the list of commercial venues that the user wants to check-in. The following is an example query that may be generated by check-in module 122 for this purpose:

“Please select one or more of the following locations to check-in:”
Store A
Store C
Store B
Store E
Store M

In one embodiment, for each commercial venue that a user has chosen to check-in, check-in module 122 of user system 120 may also generate one or more queries for asking the user how he wants to check-in to the commercial venue, as discussed below.

In one embodiment, check-in module 122 of user system 120 may generate one or more queries for asking the user if he would like to check-in to a commercial venue publicly, thereby resulting in the user's location broadcasted to the user's social graph; or privately without broadcasting the user's location to the social graph. The following is an example query that may be generated by check-in module 122 for this purpose:

“How would you like to check-in to store B at 1048 Reed Ave., California 97000? Please select one of the following options.”
Public Check-in
Private Check-in

In other embodiments, check-in module 122 of user system 120 may generate one or more queries for asking the user if he would like to check-in to the commercial venue anonymously without sending contextual data associated with the user to server 130, or non-anonymously resulting in the contextual data associated with the user sent to server 130. As discussed above, the contextual data associated with the user may be provided to merchant platform 180 for returning one or more targeted offer to the user based on the contextual data sent. The following is an example query that may be generated by check-in module 122 for this purpose:

“How would you like to check-in to store M at 1000 University Ave., California 90000?. Please select one of the following options.”
Anonymously Check-in
Non-anonymously Check-in

In one embodiment, the one or more queries generated by check-in module 122 may be provided to display module 128 for displaying to the user in a user interface (e.g., GUI). Using a keypad, touch screen, or similar mechanism on the user device, the user may select one or more commercial venues to check-in and/or one or more check-in options for checking-in to each commercial venue that the user has selected to check-in.

As discussed above, if a user chooses to check-in to commercial venues anonymously, then no contextual data associated with the user is sent to server 130. There are many reasons that a user may check-in to a commercial venue anonymously. For example, the user may be only interested in announcing to his friends of his current location, but does not care much about the offers and discounts provided by the commercial venue. In such a case, a user may select the “public check-in” option, and the “anonymous check-in” option in response to the queries generated by check-in module 122.

There are many different queries and/or options that may be provided to a user by check-in module 122. Check-in module 122 may be configured to generate more or less queries than those examples discussed above. For example, check-in module 122 may generate one or more queries for asking a user when he would like to check-in to a particular commercial venue, and whether he would like to check-in for his family members or friends, etc. Other queries may also be generated by check-in module 122 such as queries for asking a user for additional contextual data that is not otherwise provided by user system 120, or queries for asking the user whether to exclude certain information in the contextual data from being sent to server 130. For example, a user may be queried to confirm if he wants to exclude his bank account information from being sent to server 130.

If a user chooses to check-in to a particular commercial venue and further chooses how he wants to check-in to the commercial venue (e.g. privately and anonymously, privately and non-anonymously, publicly and anonymously, or publicly and non-anonymously), then check-in module 122 may generate a check-in request message associated with the user and forward the check-in request message to server 130 via communication module 124. In one embodiment, a check-in request message associated with a user may be generated by check-in module 122 for each commercial venue that the user has selected to check-in. A check-in request message generated by check-in module 122 may include information identifying a user who initiates the check-in request, information identifying a commercial venue that the user has selected to check-in, information identifying one or more check-in options selected by the user (e.g., public, private, anonymous, non-anonymous, etc.), contextual data associated with the user, and other information associated with the user. If the user has chosen to check-in anonymously, then in some embodiments the check-in request will not include the contextual data associated with the user.

Database 127 of user system 120 may be implemented as one or more databases that retrieve (extract) data from other data stores such as database 160 of server 130, perform calculations on the retrieved data to generate and aggregate metric data, provide data to display module 128, and perform other business logic. In one embodiment, database 127 may collect and store various data and information associated with a user. For example, database 127 of user system 120 may collect and store contextual data associated with the user. As discussed above, the contextual data associated with a user may include information related to the user's location history, information related to his past shopping history, information related to one or more friends of the user, and other relevant information associated with the user.

User system 120 may also include other modules and components for implementing the present technology. In some embodiments, user system 120 may include an export module (not shown in FIG. 1) that is configured to export data or other information associated with a user to external devices such as an USB device, a printer, an external hard drive, and the like. The information exported may include a list of one or more offers received by the user from merchant platform 180, data stored in database 127 such as the contextual data associated with the user. In some embodiments, user system 120 may include one or more tools for querying the data stored in databases such as database 127, tools for generating reports, tools for analyzing the data stored in database 127, and other tools for manipulating the information collected and stored by user system 120 and/or server 130.

Returning to FIG. 1, server 130 of system 100 may be configured to provide various services and resources for users and merchants related to check-in to commercial venues. For example, server 130 may include services and resources for a user to check-in to one or more commercial venues via user system 120 according to one or more check-in options and other information provided by the user, and may further include services and resources for a merchant to configure one or more offers to be returned to a user based on contextual data associated with the user. In one embodiment, server 130 may include a communication module 150, a database 160, and a merchant platform 180. Communication module 150 may be configured to enable communications between server 130 and other systems or sub-systems in system 100. The modules and components in sever 130 may be implemented in software (e.g., code, program, instructions that are stored on a machine-readable medium and executed by a processor), hardware, or combinations thereof.

Merchant platform 180 may be configured to register one or more merchants, configure one or more offers for a merchant based on information provided by the merchant, process a check-in request associated with a user based upon one or more check-in options and other information provided by the user, return one or more target offers to a user based on contextual data associated with the user, and perform other actions for a user and/or a merchant. In one embodiment, merchant platform 180 may include a registration and authentication module 182, a configuration module 184, a processing module 186, and tools 188. In one embodiment, merchant platform 180 may be implemented via web services to provide various services and resources to a merchant via the web. For example, configuration module 184 of merchant platform 180 may provide configuration services for a merchant to configure one or more offers with each offer configured having an associated condition (discussed below). As discussed above, access module 112 of merchant system 110 may implement a web browser for a merchant to access the various services and resources provided by merchant platform 180 via the web.

In one embodiment, registration and authentication module 182 of merchant platform 180 may be configured for registering a merchant with merchant platform 180. In one embodiment, registering a merchant by registration and authentication module 182 may require the merchant to provide information associated with the merchant, such as a name and address of the merchant, number of employees, types of business, years in business, annual revenues, and other relevant information. The information provided by the merchant to registration and authentication module 182 may be verified by registration and authentication module 182 or some other modules using any well-know verification process to complete the registration process for the merchant. In one embodiment, the information provided by a merchant to registration and authentication module 182 may be stored in database 160.

Once a merchant is properly registered with merchant platform 180, the merchant is designated as a “registered” merchant and may access the various services and resources provided by merchant platform 180. In one embodiment, each registered merchant platform 180 is assigned an identifier identifying the registered merchant and a status designation associated with the registered merchant. The status associated with a registered merchant may include any arbitrary designation that indicates a current state of the registered merchant. For example, a status designation associated with a registered merchant may include an “active” designation indicating that the merchant has regularly issued coupons and discount offers to users for the past three months, an “inactive” designation indicating that the merchant has not issued any coupons and discount offers to users for a period of time, a “valued” designation indicating that the merchant has been checked-in the most frequent (or in the top X merchants) for the past two weeks among all the register merchants of merchant platform 180, and other arbitrary designations. In one embodiment, information associated with a registered merchant is stored in database 160. For example, for each registered merchant of merchant platform 180, database 160 may store an identifier and a status designation associated with the registered merchant.

In one embodiment, registration and authentication module 182 is further configured to authenticate a registered merchant who wishes to access the various services and resources provided by merchant platform 180 and/or server 130 whenever and wherever that the merchant may desire. For example, a registered merchant may wish to access the data stored in database 160, or to configure a list of one or more offers for the holiday seasons, and the like. Different system administrators may have different security requirements according to the business needs of the systems they administer and they may require different types of authentication mechanisms. For example, some authentication systems may only require presenting a simple merchant identification and/or password. Other authentication systems may be more sophisticated and require a merchant to employ authentication mechanisms such as a smart card, a token card, a fingerprint scanner, and/or other mechanisms. After a merchant is properly authenticated, the merchant may then access the various services and resources provided by merchant platform 180 and/or server 130.

In one embodiment, configuration module 184 of merchant platform 180 may configure a set of one or more offers for a registered merchant with each offer configured having a corresponding condition associated with the offer. In one embodiment, using a keypad, touch screen, or similar mechanism on a merchant device, a registered merchant may specify to configuration module 184 an offer including the offer details and the corresponding condition associated with the offer. For example, assuming that store B is a registered merchant for merchant platform 180, store B wants to configure an offer on selected cameras sold in all of its stores for users who have not purchased camera in the last year or alternatively for users who have recently graduated from college using the services provided by configuration module 184. Thus, the following information may be specified and provided by store B to configuration module 184:
Offers: 50% discount on selected cameras sold in all stores from Jan. 1, 2011-Mar. 1, 2011;
Condition for the offer configured: for users who have not purchased camera in the last year or alternatively for users who have recently graduated from college.

Based upon the offer specification provided by a registered merchant (e.g., store B), configuration module 184 may then create an offer for the registered merchant that includes the offer details as well as the corresponding condition associated with the offer configured. In one embodiment, a data structure may be created (e.g. by the system administrator) for the one or more offers configured for a registered merchant. The data structure may include one or more data fields such as an “offer” field that specifies the offer details for an offer, a “condition” field that specifies the condition associated with the offer, a “start date” field indicating the start date for the offer to take effect, an “expiration date” field indicating the date that the offer expires, and other data fields. An offer may be created by configuration module 184 by generating a set of data that includes the information provided by the registered merchant and writing the set of data into the respective fields of the data structure. In one embodiment, the data structure may be implemented in configuration module 184.

In one embodiment, an offer created by configuration module 184 for a registered merchant and the corresponding condition associated with the offer may be stored in database 160 in one or more entries corresponding to the merchant. As discussed above, database 160 may store various information associated with a registered merchant, e.g., an identifier identifying the registered merchant, a status designation associated with the registered merchant, a set of one or more offers configured for the registered merchant, and a condition associated with each of the one or more offers configured for the registered merchant, etc.

In one embodiment, processing module 186 is configured to receive a check-in request message associated with a user. As discussed about, a check-in request message associated with a user may include information identifying the user who initiates the check-in request, information identifying a commercial venue that the user has requested to check-in to, information identifying one or more check-in options such as public, private, anonymous, non-anonymous, contextual data associated with the user if any, and other information associated with the user.

In one embodiment, in response to the check-in request message associated with the user, processing module 186 is configured to determine if the commercial venue identified in the check-in request message is associated with a registered merchant of merchant platform 180. In one embodiment, processing module 186 may search database 160 to determine if there are one or more entries in database 160 storing information associated with the commercial venue. If there are one or more entries in database 160 storing information associated with the commercial venue, then the commercial venue identified in the check-in request message is associated with a registered merchant of merchant platform 180.

If the commercial venue identified in the check-in request message is not associated with a registered merchant of merchant platform 180, then processing module generates a message informing the user that the commercial venue that the user has requested to check-in is not currently supported by merchant platform 180 and forward the message to the user via communication module 150. Alternatively, processing module 186 may generate a message recommending a list of one or more registered merchants of merchant platform 180 that the user may be interested in checking-in.

On the other hand, if processing module 186 determines that the commercial venue identified in the check-in request message is associated with a registered merchant of merchant platform 180, then processing module 186 may access information included in the check-in request message to retrieve information identifying the user's check-in option(s), such as public, private, anonymous, and non-anonymous check-in options.

If the information in the check-in request message indicates that the user has chosen to check-in to the registered merchant anonymously, then processing module 186 is configured to generate a default message and send the default message to the user via communication module 150. The default message generated by processing module 186 in response to the anonymous check-in request may include a generic offer configured for the registered merchant and other information associated with the registered merchant, e.g., information informing the user of an upcoming sale by the registered merchant.

On the other hand, if it is determined by processing module 186 that the user has chosen to check-in to the registered merchant non-anonymously, then processing module 186 is configured to determine if there are one or more target offers configured and/or stored in database 160 for the registered merchant that may be returned to the user based on the contextual data associated with the user. In one embodiment, processing module 186 is configured to compare the contextual data included in the check-in request message with the condition associated with each of the one or more targeted offers configured and/or stored in database 160 for the registered merchant, and determine if the contextual data included in the user's check-in request message satisfies the condition associated with each of the one or more targeted offers configured and/or stored in database 160 for the registered merchant.

If the contextual data included in the user's check-in request message satisfies the condition associated with a particular offer configured for the registered merchant, then a response message may be generated and communicated to the user. The response message generated may include information identifying the particular offer corresponding to the condition that was satisfied by the contextual data included in the user's check-in request message based on the determination performed by processing module 186. In one embodiment, the response message generated may include information identifying more than one offer if the contextual data included in the user's check-in request message satisfies more than one condition. The one or more offers identified in the response message may be displayed to the user by display module 128 in a user interface (e.g., GUI).

In one embodiment, if the information in the check-in request message indicates that the user has chosen to check-in to the registered merchant publicly, then processing module 186 is configured to broadcast the user's current check-in location to the user's social graph.

On the other hand, if the information in the check-in request message indicates that the user has chosen to check-in to the registered merchant privately, then processing module 186 is configured to keep the user's current check-in location confidential by not broadcasting the user's current check-in location to the user's social graph.

Returning to FIG. 1, database 160 of server 130 may be implemented as one or more databases that retrieve (extract) data from other data stores such as databases 116 and 127, perform calculations on the retrieved data to generate and aggregate data, provide data to display modules 118 and 128, and perform other business logic. In one embodiment, database 160 may collect and store various data and information associated with registered merchants. For example, for each registered merchant of merchant platform 180, database 160 stores an identifier associated with the registered merchant, a status designation associated with the registered merchant, a list of one or more targeted offers configured for the registered merchant, and the corresponding condition associated with each of the one or more offers configured for the registered merchant, and other information associated with the registered merchant. In one embodiment, database 160 may store a current counter value for each of the one more offers stored in the database. The current counter value stored for each offer in database 160 may indicate a total number of times that the offer has been successfully delivered to one or more users during a given period of time. Database 160 may also store information associated with a user. For example, database 160 may store contextual data associated with the user.

Various tools 188 may be provided as part of merchant platform 180. Tools 188 may include one or more tools for querying the data stored in database 160, tools for generating reports, tools for analyzing the data stored in database 160, and other tools that may use information collected and stored by server 130. Tools 188 may also include one or more counters associated with the one or more offers configured for a particular merchant and stored in database 160. For example, a counter may be provided to track a total number of times that a particular offer has been successfully delivered to users for a given period of time. The counter may be set to an initial default value of zero and incremented by one each time that the offer is successfully delivered to a user. A current counter value for the counter may be stored in database 160 for the offer.

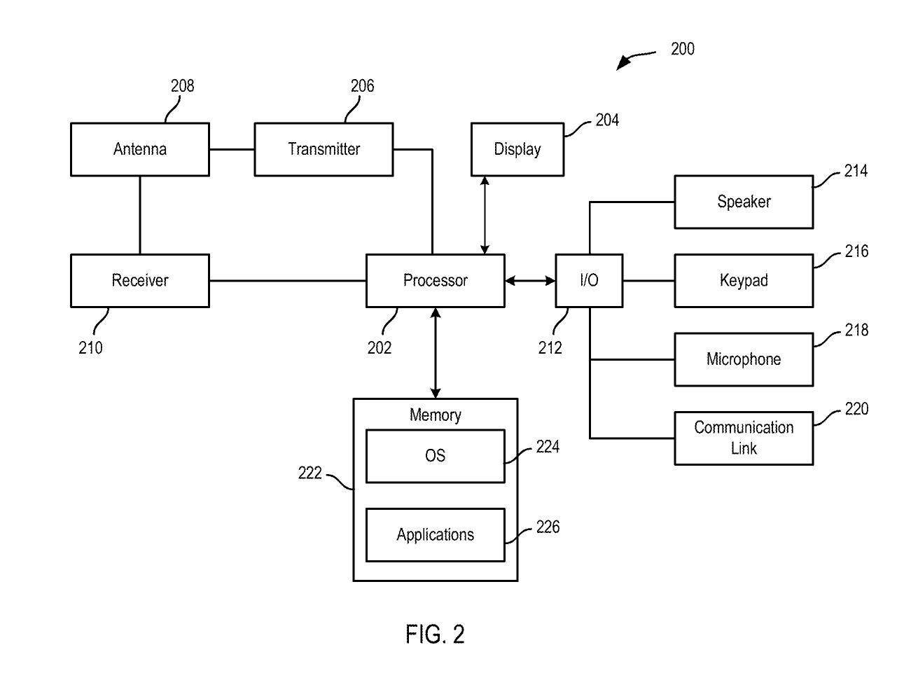

FIG. 2 illustrates an example of a suitable mobile computing device 200 for implementing aspects of the present technology as will be described. In one embodiment, mobile computing device 200 of FIG. 2 provides more detail for user system 120 of FIG. 1. Those of ordinary skill in the art will appreciate that mobile device 200 includes many more components than those illustrated in FIG. 2. However, it is not necessary that all of these generally conventional components be shown in order to disclose an illustrative embodiment for practicing the present technology. Additionally, those of ordinary skill in the art will further appreciate that alternative components and/or methods for establishing mobile communications is considered within the scope of the present technology.

As shown in FIG. 2, mobile device 200 includes a processor 202, a display 204, and a memory 222. Display 204 may include any variety of display devices including, but not limited to a liquid crystal display, a color display, and/or a light emitting diode display. Additionally, display 204 may also provide a touch screen interface. Also connected to processor 202 is an input/output interface 212, which connects to a speaker 214, a keypad 216, a microphone 218, and a communication link 220, such as a base station connection. As would be readily understood by one skilled in the relevant art, alternative input/output configurations are considered to be within the scope of the present technology.

Mobile device 200 may also include a transmitter 206 and a receiver 210, which are connected to an antenna 208 for sending and receiving wireless communications respectively. Mobile device 200 may also include a modulator and demodulator for formatting data transmissions according to an air interface standard. It should be understood that mobile device 200 may be capable of operating with one or more air interface standards, modulation types and data accessing types without departing from the scope of the present technology.

Memory 222 generally comprises a RAM, a ROM, and may also include a permanent mass storage device, such as a hard disk drive, tape drive, optical drive, floppy disk drive, CD-ROM, DVD-ROM, flash memory or removable storage drive. Memory 222 stores an operating system 224 for controlling operation of mobile device 200. Memory 222 may also include a number of additional applications 226 that provide various functions and services to mobile device 200. In one aspect of the present technology, at least one application 226 is operable to transmit and/or receive messages from external software applications, such as a server computing device. As would be readily understood, memory 222 may contain additional applications for accessing multiple networks. It will be appreciated that these components may be stored on various computer-readable mediums and loaded into memory 222 using a drive medium associated with the computer-readable medium.

Although the present technology will described with respect to an illustrative mobile device 200, one skilled in the relevant art will appreciate that the present technology is applicable to a number of devices having some computing resources. Accordingly, the disclosed embodiments should not be construed as limiting.

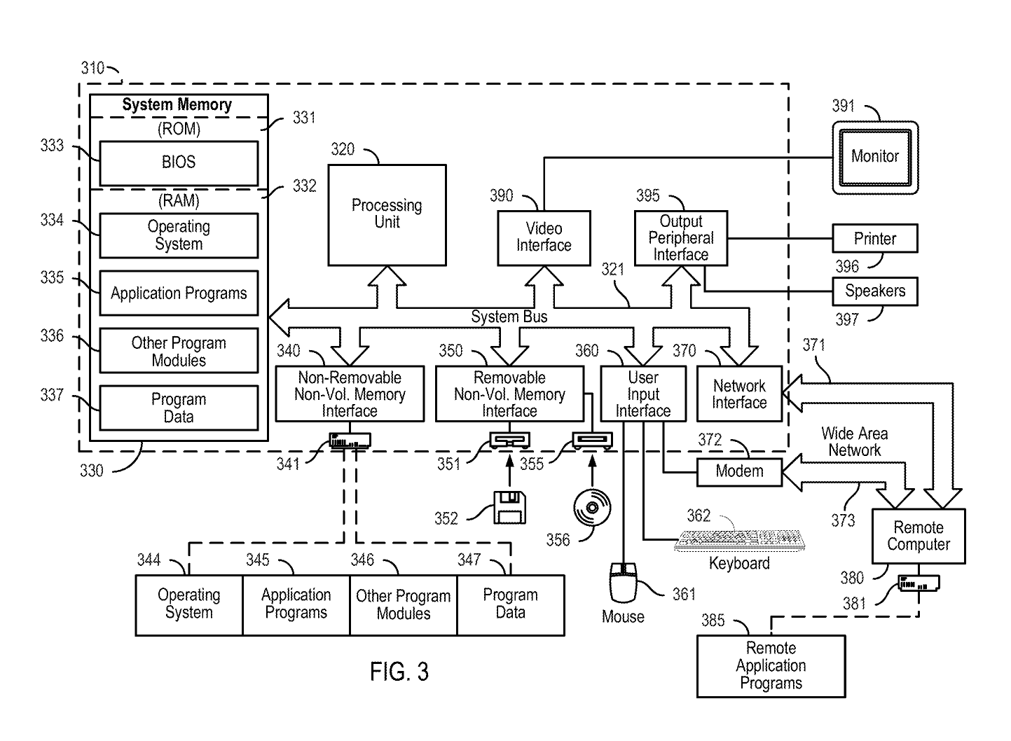

FIG. 3 is an example of a computing device for implementing the present technology. In one embodiment, the computing device of FIG. 3 provides more detail for merchant system 110, user system 120, and server 130 of FIG. 1. The computing device of FIG. 3 is only one example of a suitable computing environment and is not intended to suggest any limitation as to the scope of use or functionality of the present technology. Neither should the computing environment be interpreted as having any dependent requirement relating to any one or combination of components illustrated in the exemplary operating environment.

The present technology is operational in numerous other general purpose or special computing system environments or configurations. Examples of well known computing systems, environments, and/or configurations that may be suitable for implementing the present technology include, but are not limited to personal computers, server computers, laptop devices, multiprocessor systems, microprocessor-based systems, network PCs, minicomputers, mainframe computers, distributed computing environments that include any of the above systems or the like.

The present technology may be described in the general context of computer-executable instructions, such as program modules, being executed by a computer. Generally, program modules include routines, programs, objects, components, data structures, etc. that perform a particular task or implement particular abstract data types. The present technology may be also practiced in distributed computing environments where tasks are performed by remote processing devices that are linked through a communications network. In a distributed computing environment, program modules may be located in both local and remote computer storage media including memory storage devices.

With reference to FIG. 3, an exemplary system for implementing the technology herein includes a general purpose computing device in the form of a computer 310. Components of computer 310 may include, but are not limited to, a processing unit 320, a system memory 330, and a system bus 321 that couples various system components including system memory 330 to processing unit 320. System bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

System memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

Computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Hard disk drive 341 is typically connected to system bus 321 through a non-removable memory interface such as interface 340, and magnetic disk drive 351 and optical disk drive 355 are typically connected to system bus 321 by a removable memory interface, such as interface 350.

The drives and their associated computer storage media discussed above and illustrated in FIG. 3, provide storage of computer readable instructions, data structures, program modules and other data for computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into computer 30 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to system bus 321 via an interface, such as a video interface 390. In addition to the monitor, computers may also include other peripheral output devices such as speakers 397 and printer 396, which may be connected through an output peripheral interface 390.

Computer 310 may operate in a networked environment using logical connections to one or more remote computers, such as a remote computer 380. Remote computer 380 may be a personal computer, a server, a router, a network PC, a peer device or other common network node, and typically includes many or all of the elements described above relative to computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, computer 310 is connected to LAN 371 through a network interface or adapter 370. When used in a WAN networking environment, computer 310 typically includes a modem 372 or other means for establishing communications over WAN 373, such as the Internet. Modem 372, which may be internal or external, may be connected to system bus 321 via user input interface 360, or other appropriate mechanism. In a networked environment, program modules depicted relative to computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

Those skilled in the art will understand that program modules such as operating system 334, application programs 345, and data 337 are provided to computer 310 via one of its memory storage devices, which may include ROM 331, RAM 332, hard disk drive 341, magnetic disk drive 351, or optical disk drive 355. Hard disk drive 341 is used to store data 337 and the programs, including operating system 334 and application programs 345.

When computer 310 is turned on or reset, BIOS 333, which is stored in ROM 331 instructs processing unit 320 to load operating system 334 from hard disk drive 341 into RAM 332. Once operating system 334 is loaded into RAM 332, processing unit 320 executes the operating system code and causes the visual elements associated with the user interface of the operating system to be displayed on the monitor. When a user opens an application program 345, the program code and relevant data are read from hard disk drive 341 and stored in RAM 332.

Aspects of the present technology may be embodied in a World Wide Web (“WWW”) or (“Web”) site accessible via the Internet. For example, merchant platform 180 of FIG. 1 may be implemented via web services as will be described below. As is well known to those skilled in the art, the term “Internet” refers to the collection of networks and routers that use the Transmission Control Protocol/Internet Protocol (“TCP/IP”) to communicate with one another. In accordance with an illustrative embodiment of the Internet, a plurality of local LANs and a WAN can be interconnected by routers. The routers are special purpose computers used to interface one LAN or WAN to another.

Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art. Furthermore, computers and other related electronic devices can be remotely connected to either the LANs or the WAN via a digital communications device, modem and temporary telephone, or a wireless link. The Internet has recently seen explosive growth by virtue of its ability to link computers located throughout the world. As the Internet has grown, so has the WWW.

As is appreciated by those skilled in the art, the WWW is a vast collection of interconnected or “hypertext” documents written in HyperText Markup Language (“HTML”), or other markup languages, that are electronically stored at or dynamically generated by “WWW sites” or “Web sites” throughout the Internet. Additionally, software programs that are implemented in merchant system 110 of FIG. 1 and communicate over the Web using the TCP/IP protocol, are part of the WWW, such as JAVAS applets, instant messaging, e-mail, browser plug-ins, Macromedia Flash, chat and others. Other interactive hypertext environments may include proprietary environments such as those provided by an number of online service providers, as well as the “wireless Web” provided by various wireless networking providers, especially those in the cellular phone industry. It will be appreciated that the present technology may apply in any such interactive communication environments. For purposes of discussion, the Web is used as an exemplary interactive hypertext environment with regard to the present technology.

A Web site is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a Web site elsewhere on the Internet. Each hyperlink is assigned a Uniform Resource Locator (“URL”) that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVAS programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Microsoft's Internet Explorer, is a software application program for providing a user interface to the WWW. Using the web browser via a remote request, the web browser requests the desired hypertext document from the appropriate web server using the URL for the document and the HyperTextTransport Protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

As discussed above, a user may select one or more commercial venues to check-in (e.g., from a list of one or more commercial venues identified in the location information received by user system 120). Further, for each commercial venue that the user has selected to check-in, the user may select one or more check-in options (e.g., anonymous, non-anonymous, private, or public).

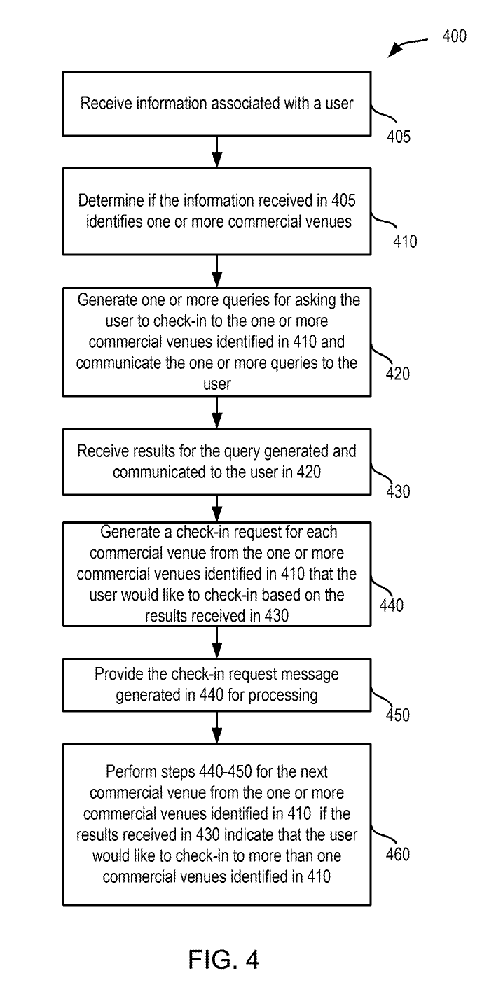

FIG. 4 is a simplified flow chart depicting a process 400 for a user to check-in to one or more commercial venues according to an embodiment of the present technology. In one embodiment, the processing depicted in FIG. 4 may be performed by user system 120 and/or server 130 of FIG. 1.

Referring to FIG. 4, at step 405, information associated with a user is received. In one embodiment, the information received at step 405 may be received by location module 126 of user system 120. For example, location module 126 of user system 120 may implement a technology (e.g., the Bluetooth technology) for sensing signals emitted from other devices or systems (e.g., signals broadcasted from the GPS system, and/or signals emitted from a commercial venue). In one embodiment, the information received in 405 may include one or more GPS signals broadcasted from a GPS system. In another embodiment, the information received in 405 may include one or more signals broadcasted from one or more commercial venues. For example, when a user is within close proximity to a commercial venue (e.g., within a 0.25-mile radius), location module 126 of user system 120 may receive one or more signals emitted from a speaker device installed in the commercial venue that are inaudible to human ears. In one embodiment, location module 126 may implement the Bluetooth technology for sensing signals emitted from commercial venues.

In one embodiment, the information received in 405 may identify a current location of the user and a list of one or more commercial venues within close proximity to the user's current location.

At 410, process 400 determines if the information received at 405 identifies one or more commercial venues. In one embodiment, step 410 may be performed by check-in module 122 of user system 120. For example, database 127 of user system 120 may store information related to a list of one or more commercial venues including name of the commercial venues, address of commercial venues, and other information. Check-in module 122 may search database 127 to determine if the information received at step 405 identifies any commercial venue from the list of commercial venues stored in database 127. Thus, by searching database 127, check-in module 122 may conclude that the information received in 405 identifies one or more commercial venues from the list of commercial venues stored in database 127. However, there may be no commercial venues that can be identified from the information received in 405. In this latter case, processing 400 is terminated.

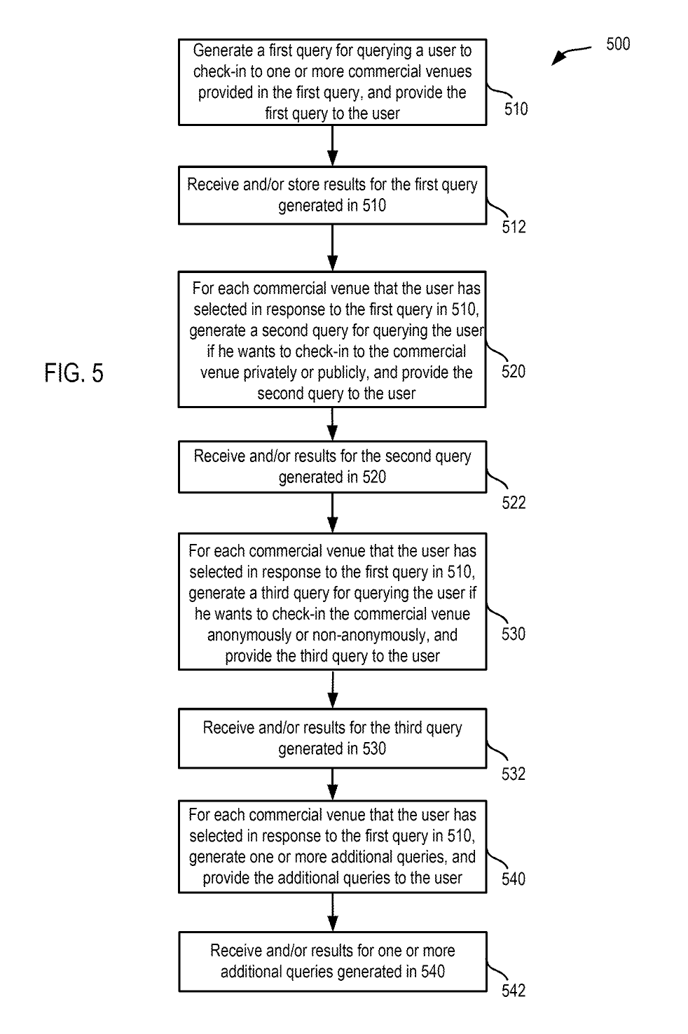

At 420, one or more queries may be generated for asking the user if he would like to check-in to the one or more commercial venues identified in 410 and how he would like to check-in to the one or more commercial venues identified in 410. In one embodiment, step 420 may be performed by check-in module 122 of user system 120. For example, a first query may be generated to ask the user to check-in to one or more commercial venues from the list of one or more commercial venues identified in 410, a second query may be generated to ask the user to select a private check-in option or a public check-in option, and a third query may be generated to ask the user to select an anonymous check-in option, or a non-anonymous check-in option. Generating one or more queries for asking a user to check-in to one or more commercial venues is discussed in more detail below with respect to the process of FIG. 5. The one or more queries generated in step 420 may be communicated to the user via display module 128 and displayed to the user via an user interface (e.g., GUI).

At 430, results for the query generated in 420 may be received from the user. In one embodiment, results for the query generated in 420 may be received by check-in module 122 of user system 120. The results received in 430 may indicate the particular commercial venue(s) from the one or more commercial venues identified in 410 that the user would like to check-in and how the user would like to check-in to the particular commercial venue(s). For example, results received in 430 may indicate that the user would like to check-in to a particular commercial venue from the one or more commercial venues identified in 410 privately and anonymously. Alternatively, the results received in 430 may indicate that the user would like to check-in to a particular commercial venue from the one or more commercial venues identified in 410 publicly and non-anonymously. In yet another example, the results received in 430 may indicate that the user would like to check-in to a particular commercial venue from the one or more commercial venues identified in 410 according to some other check-in options or combinations of these check-in options that the user has selected in response to the one or more queries generated in step 420. However, the results received in 430 may indicate that the user does not want to check-in to any of the one or more commercial venues identified in 410. In this case, processing 400 is terminated.

At 440, based on the results received in 430, a check-in request may be generated for each commercial venue from the one or more commercial venues identified in 410 that the user would like to check-in. In one embodiment, the check-in request may be generated by check-in module 122 of FIG. 1. In one embodiment, the check-in request generated in 440 may include information identifying the user who initiates the check-in request, information identifying the commercial venue that the user has requested to check-in, information identifying the user's check-in option (i.e., how the user would like to check-in to the commercial venue, such as public, private, anonymous, non-anonymous, etc.), contextual data associated with the user (e.g., if the user has chosen to check-in to the commercial venue non-anonymously in response to the query generated in 420), and other information associated with the user.

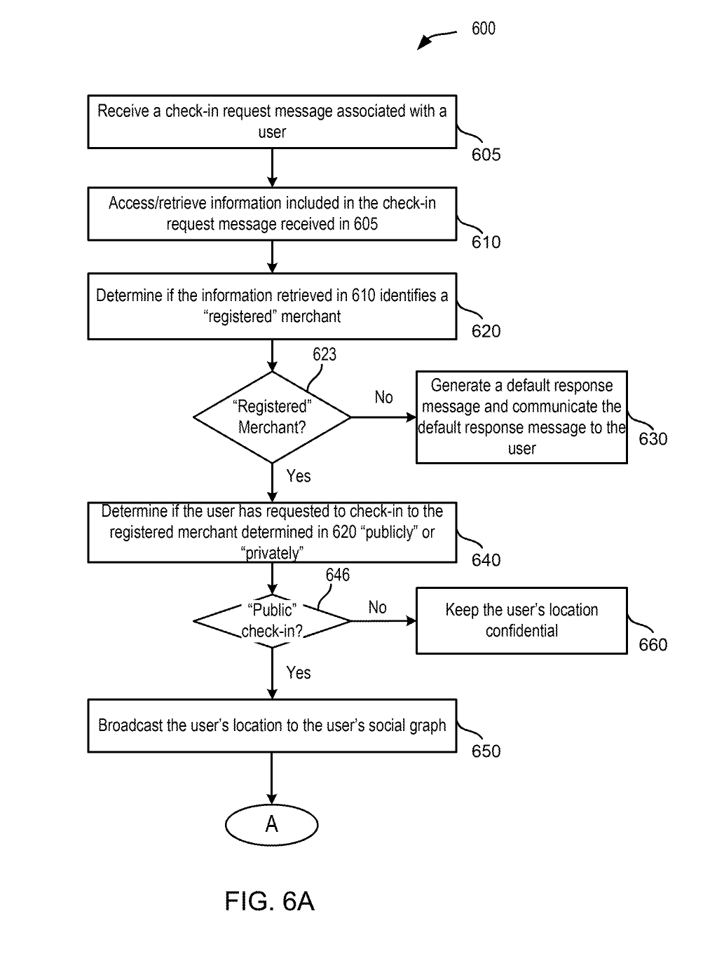

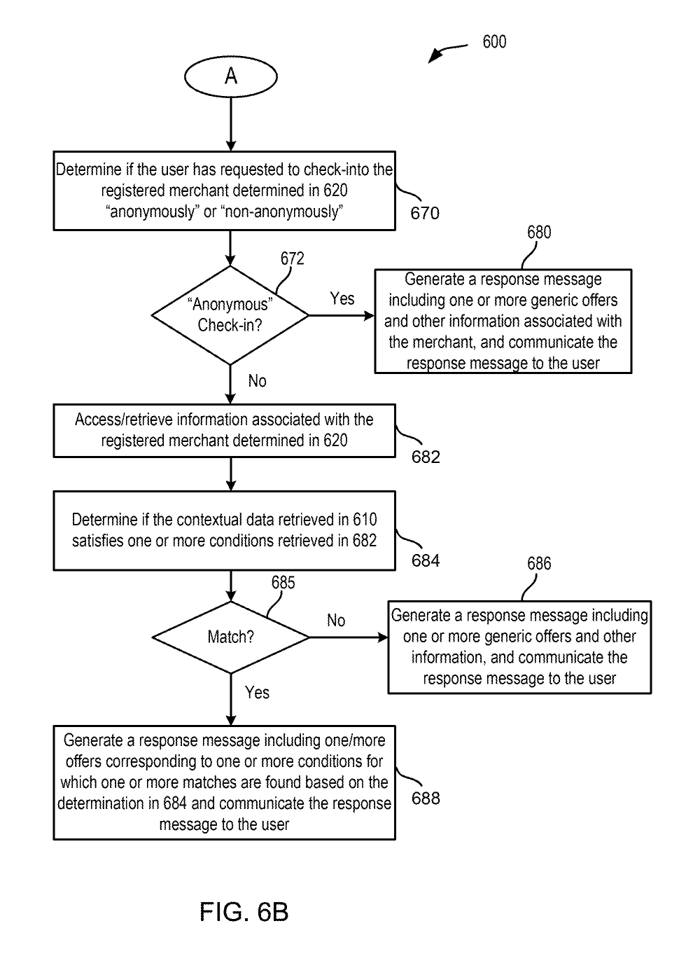

At 450, the check-in request generated in 440 may be provided to other modules and systems for processing. In one embodiment, the check-in request generated in 440 is communicated to server 130 via communication module 124 and provided to merchant platform 180 for further processing. For example, the check-in request generated in 440 may be processed by merchant platform 180 of FIG. 1 to return one or more offers configured for the merchant (i.e., the merchant who is identified in the check-in request message generated in 440) to the user based on the contextual data associated with the user. Processing of the check-in request generated in 440 is discussed in more detail below with respect to the process of FIGS. 6A and 6B.

At 460, steps 440 and 450 may be performed for the next commercial venue if the results received in 430 indicate that the user would like to check-in to more than one commercial venues from the one or more commercial venues identified in 410.

FIG. 5 is a simplified flow chart depicting a process 500 for querying a user to check-in to one or more commercial venues according to an embodiment of the present technology. The processing depicted in FIG. 5 may be performed by check-in module 122 of FIG. 1. The processing depicted in FIG. 5 provides more details for step 420 of FIG. 4.

Referring to FIG. 5, at 510, a first query may be generated for querying a user to check-in to one or more commercial venues identified in the first query. For example, the one or more commercial venues identified in the first query may be the one or more commercial venues identified in step 410 of FIG. 4. In one embodiment, the first query is generated by check-in module 122 of FIG. 1.

For example, assuming that there are five commercial venues identified in 410 of FIG. 4, a first query may be generated at 510 as shown below:

“Please select one or more of the following locations to check-in:”
Store A
Store B
Store C
Store D
Store E

In one embodiment, the first query generated in 510 may be displayed to the user in a user interface (e.g., GUI). Using a keypad, touch screen, or similar mechanism on the user device, the user may select one or more commercial venues identified in the query generated in 510 to request a check-in. Alternatively, the user may not select any commercial venue from the list of commercial venues identified in the query generated in 510. This may be the case if the user is not interested in checking-in to any commercial venues identified in the query generated in 510.

At 512, results for the first query generated in 510 are received and/or stored. In one embodiment, the results for the first query may be stored in database 127 of FIG. 1. The results for the first query may indicate one or more commercial venues that the user would like to check-in or alternatively not to check-in at all.

As discussed below, processing steps 520, 522, 530, 532, 540, 542, and 550 of FIG. 5 may be performed for each commercial venue that the user has selected in response to the first query generated in 510. Processing steps 520, 530, and 540 may be performed in any order or sequence other than the order illustrated in FIG. 5.

At 520, for each commercial venue that the user has selected in response to the first query generated in 510, a second query may be generated for querying the user whether to check-in to the selected commercial venue privately or publicly. In one embodiment, the second query generated in 520 may be displayed to the user in a user interface (e.g., GUI).

The following is an example query that may be generated at 520:

“How would you like to check-in to store B at 1048 Reed Ave, California 97000? Please select one of the following check-in options:”
Public Check-in
Private Check-in

In response to the second query generated in step 520, the user may select one of the check-in options identified in the second query (e.g., the user may use a keypad, touch screen, or similar mechanism on the user device to make a selection). For example, the user may respond to the second query by selecting the “public check-in” option, indicating that the user would like to have his location information broadcasted to his social graph. Alternatively, the user may respond to the second query generated in 520 by selecting the “private check-in” option, indicating that the user does not want to have his location published to his social network.

At 522, results for the second query generated in 520 are received and/or stored. In one embodiment, the results for the second query may be stored in database 127 of FIG. 1. The results for the second query may indicate whether the user would like to check-in to the selected commercial venue publicly or privately.

At 530, for each commercial venue that the user has selected in response to the first query generated in 510, a third query may be generated for querying the user whether to check-in to the selected commercial venue anonymously or non-anonymously. In one embodiment, the third query generated in 520 may be displayed to the user in a user interface (e.g., GUI).

The following is an example query that may be generated at 530:

“Please select one of the following check-in options:”
Anonymous Check-in
Non-anonymous Check-in

In response to the third query generated in step 530, the user may select one of the check-in options identified in the third query (e.g., the user may use a keypad, touch screen, or similar mechanism on the user device to make a selection). For example, the user may select the “anonymous check-in” option, or alternatively the user may select the “non-anonymous check-in” option, thereby making the contextual data associated with the user available to other modules/components (e.g., merchant platform 180) for processing and other uses. As discussed, the contextual data associated with the user may be provided for merchant platform 180 to return one or more target offers to the user based on the contextual data.

At 532, results for the third query generated in 530 are received and/or stored. In one embodiment, the results for the third query may be stored in database 127 of FIG. 1. The results for the third query may indicate whether the user would like to check-in to the selected commercial venue anonymously or non-anonymously.

At 540, for each commercial venue that the user has selected in response to the first query generated in 510, one or more other queries and/or instructions may be generated for querying and/or instructing the user to select other check-in options or for querying the user for additional information. For example, one or more queries may be generated at 540 for querying the user when he would like to check-in to a particular commercial venue, and/or if he would like to check-in for others such as his family members and/or friends, etc. Queries may also be generated at 540 for querying the user for additional data and information such as additional contextual data associated with the user which is not otherwise provided by the user device, or queries for querying the user whether to exclude certain contextual data associated with the user from being sent to merchant platform 180 for processing or other uses.

At 542, results for the queries generated in 540 are received and/or stored. In one embodiment, the results for the third query may be stored in database 127 of FIG. 1.

FIGS. 6A and 6B are simplified flow charts depicting a process 600 for processing a check-in request associated with a user and for proving one or more offers to the user according to an embodiment of the present technology. The processing depicted in FIGS. 6A and 6B may be performed by merchant platform 180 and other modules/components of server 130 of FIG. 1. The processing depicted n FIGS. 6A and 6B provide more details for step 450 of FIG. 4.

At 605, a check-in request message associated with a user is received. In one embodiment, the check-in request message received in 610 may include information identifying the user who initiates the check-in request, information identifying a commercial venue that the user has requested to check-in, information identifying one or more check-in options (e.g., public or private, anonymous or non-anonymous) associated with the user, contextual data associated with the user, and other information associated with the user. In one embodiment, the check-in request message received in 605 may be received by merchant platform 180 of FIG. 1.

At 610, process 600 accesses the information included in the check-in request message received in 605 to retrieve the following information, if any:
Information identifying the user who initiates the check-in request;
Information identifying a commercial venue (merchant) that the user has requested to check-in;
Information identifying one or more check-in option associated with the user (e.g., public vs. private, anonymous vs. non-anonymous);
Contextual data associated with the user if any; and
Other information for executing the various steps of process 600.

At 620, based on the information retrieved in 610, process 600 determines if the information retrieved in 610 identifies a “registered” merchant (e.g., a registered merchant for merchant platform 180) that the user has requested to check-in and for whom the check-in request was received in 605. In one embodiment, process 600 may access database 160 which stores information for each registered merchant for merchant platform 180, and determines if there are one or more corresponding entries in database 160 that store information associated with the merchant that the user has requested to check-in. The information stored in database 160 for each registered merchant may include an identifier identifying the registered merchant, a status designation associated with the registered merchant indicating a current state of the registered merchant, a list of one or more offers configured for the registered merchant, a condition associated with each of the one or more offers configured for the registered merchant, and other relevant information associated with the registered merchant.

If there is no corresponding entry in database module 160 that stores information associated with the merchant that the user has requested to check-in, then the merchant identified in the information retrieved in 610 is not a “registered” merchant for merchant platform 180 according to step 623. As a result, step 630 may be executed, as discussed below.

At step 630, a default response message may be generated and communicated to the user. In one embodiment, the default message generated in 630 may include information informing the user that the particular merchant that the user has requested to check-in is not currently supported by the system (e.g., merchant platform 180). In other embodiments, the default message generated in 630 may include information recommending a list of one or more merchants different from the merchant that the user has requested to check-in (e.g., one or more registered merchants of merchant platform 180) and one or more queries for querying the user whether he would like to check-in to the one or more recommended merchants and how he would like to check-in to these recommended merchants.

On the other hand, if there are one or more corresponding entries in database 160 storing information associated with the merchant that the user has requested to check-in, then the merchant identified in the information retrieved in 610 is a “registered” merchant for merchant platform 180 according to step 623. In this case, step 640 may be executed, as discussed below.

At 640, based on the information retrieved in 610, process 600 determines if the user has requested to check-in to the registered merchant determined in 620 publicly or privately. As discussed above, the information retrieved in 610 may identify one or more check-in options associated with the user such as public or private check-ins, and/or anonymous or non-anonymous check-in options, etc.

If the one or more check-in options identified in the information retrieved in 610 indicate a “public” check-in option according to step 646, then at 650, the user's location information including the location of the commercial venue that the user has request to check-in may be broadcasted to the user's social graph via social networks such as Facebook and Twitter. On the other hand, if the one or more check-in options identified in the information retrieved in 610 indicate a “private” check-in option according to step 646, then at 660, the user's location is kept confidential, resulting in no broadcasting of the user's location including the location of the commercial venue that the user has request to check-in to the user's social graph.

Referring to FIG. 6B, at 670, based on the information retrieved in 610, process 600 determines if the user has requested to check-in to the particular merchant determined in 620 anonymously or non-anonymously. If the one or more check-in options identified in the information retrieved in 610 indicate an “anonymously” check-in option according to step 672, then at 680, a response message may be generated and communicated to the user. In one embodiment, the response message generated in 680 may include information identifying one or more generic offers associated with the merchant and other information associated with the merchant. For example, the one or more generic offers included in the response message generated in 680 may include an offer informing the user of an upcoming warehouse sale in the store.

On the other hand, if the one or more check-in options identified in the information retrieved in 610 indicate a “non-anonymously” check-in option according to step 672, then at 682, the information associated with the merchant determined in 620 may be retrieved. In one embodiment, the information associated with the merchant determined in 620 may be retrieved from database 160 of FIG. 1. The information associated with the merchant determined in 620 may include an identifier identifying the merchant, a status designation associated with the merchant indicating a current state of the registered merchant, a list of one or more offers configured for the merchant, a condition associated with each of the one or more offers configured for the registered merchant, and other relevant information associated with the merchant.

At 684, process 600 determines if the contextual data retrieved in 610 (if any) satisfies the one or more conditions retrieved in 682. In one embodiment, process 600 compares the contextual data retrieved in 610 with the condition associated with each offer configure for the merchant to determine if the condition associated with each offer configured for the merchant is satisfied. For example, the contextual data retrieved in 610 may indicate that the user has recently purchased three cameras from store A and has made two visits to store B in the past six months, while the condition associated with an offer configured for the merchant and retrieved in 682 may identify the following information associated with the merchant:
Offer configured for the merchant: 50% discount on selected cameras sold in all stores from Jan. 1, 2011-Mar. 1, 2011;
Condition to be satisfied for the offer configured: users who have purchased more than one camera in the last year.
   then the condition (users who have purchased more than one camera in the last year) is evaluated to be true and thus satisfied by the contextual data retrieved in 610 (the user has recently purchased three cameras from store A and has made two visits to store B in the past six months).

If the contextual data retrieved in 610 satisfies the one or more conditions retrieved in 682 according to 685, then at 688, a response message may be generated and communicated to the user. The response message generated in 688 may include information identifying one or more targeted offers corresponding to one or more conditions that were satisfied by the contextual data retrieved in 610 based on the determination performed in step 684. Referring to the above example, since the contextual data associated with the user (the user has purchased three cameras from store A) satisfies the condition associated with the offer configured (users who have purchased more than one camera in the last year), the response message generated in 688 may include information identifying the particular offer configured, namely, 50% discount on selected cameras sold in all stores from Jan. 1, 2011-Mar. 1, 2011.

On the other hand, if the contextual data retrieved in 610 does not satisfies any of the one or more conditions retrieved in 682 according to 685, then a response message is generated and communicated to the user at 686. In one embodiment, the response message generated in 686 may include information identifying one or more generic offers configured by the merchant and other information provided by the merchant. For example, the one or more generic offers included in the response message generated in 686 may include an offer informing the user of an upcoming warehouse sale in the merchant's store.

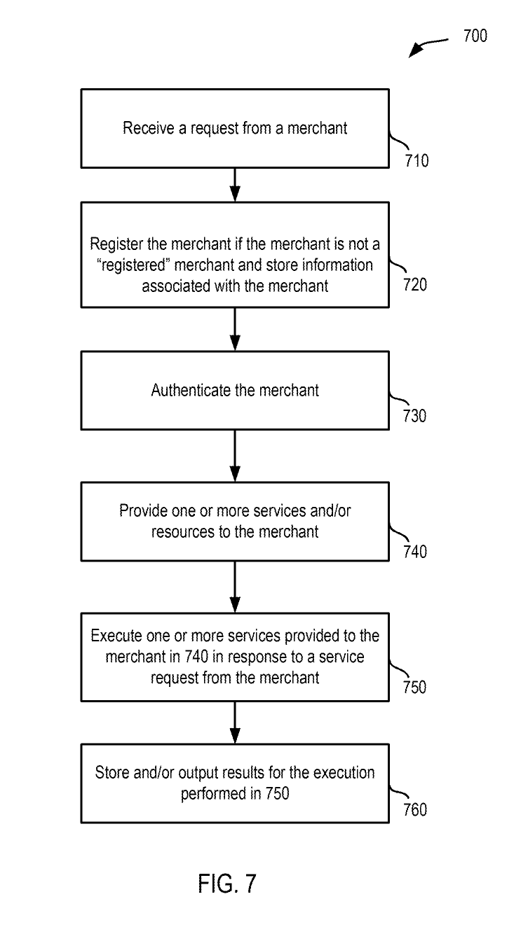

FIG. 7 is a simplified flow chart depicting a process 700 for a merchant to access one or more services provided by merchant platform 180 of FIG. 1 to a merchant according to an embodiment of the present technology. The processing depicted in FIG. 7 may be performed by merchant platform 180 of server 130 in FIG. 1.

At 710, a request may be received from a merchant. In one embodiment, the request received in 710 may be an HTTP request. In other embodiments, the request received in 710 may be a request received from a secured connection via a private network. The request received in 710 may include information associated with the merchant, e.g., information identifying the merchant, information identifying a location of the merchant, and other information associated with the merchant.

At 720, process 700 registers the merchant and/or stores information associated with the merchant if the merchant from whom the request was received in 710 is not a “registered” merchant such as a register merchant for merchant platform 180 of FIG. 1. For example, process 700 may query database 160 which may store information for each registered merchant for merchant platform 180. If there is no corresponding entry in database 160 that stores information associated with the merchant, then step 720 is executed to register the merchant and/or store information associated the merchant. Any well-known registration mechanism may be used to register the merchant.

At 730, process 700 authenticates the merchant. In one embodiment, registration and/or authentication of a merchant may be performed by registration and authentication module 182 of FIG. 1. Any well-known authentication mechanism may be used to authenticate the merchant.

At 740, one or more services and/or resources are provided to the merchant from whom the request was received in 710. For example, a configuration service may be provided to the merchant to configure one or more target offers based on contextual data. In another example, an access service may be provided to the merchant for access and retrieving information stored in a database (e.g., database 160). In yet another example, one or more tools may be provided to the merchant for analyzing data and generating one or more reports based on results of the analysis. In one embodiment, the one or more services and/or resources provided in 740 may be displayed to the merchant in a graphical user interface (e.g., GUI). Using a keypad, touch screen, or similar mechanism on the merchant device, the merchant may select one or more services and/or resources from the one or more services and/or resources provided in 740.

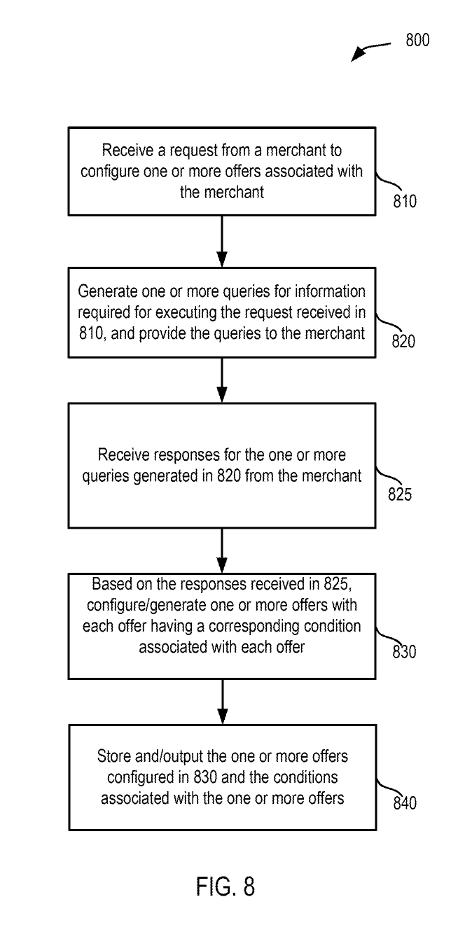

At 750, the one or more services provided in 740 may be executed in response to one or more selections by the merchant. For example, the merchant may select a “Configuration” service provided in 740 to configure one or more targeted offers based on contextual data. Configuring one or more targeted offers is discussed in more detail below with respect to the process of FIG. 8.

At 760, results for the execution performed in 750 may be store and/or output. In one embodiment, the results may be stored in database 160, and/or displayed to the merchant in a display interface (e.g., GUI).

FIG. 8 is a simplified flow chart depicting a process 800 for configuring one or more offers associated with a merchant according to an embodiment of the present technology. The processing depicted in FIG. 8 may be performed by configuration module 184 of merchant platform 180. The processing depicted in FIG. 8 provides more details for step 750 of FIG. 7.

At 810, a request is received from a merchant for configuring one or more offers associated with the merchant using one or more services provided to the merchant. In one embodiment, the request is received by configuration module 184 of FIG. 1.

At 820, one or more queries may be generated and provided to the merchant for querying the merchant for information for configuring one or more offers associated with the merchant. In one embodiment, a first query may be generated for asking the merchant to specify offer details such as what the offer is, the start date for the offer to take effect, the expiration date for the offer to expire, and other information associated with the offer. A second query may be generated for asking the merchant to specify the condition associated with the offer. A third query may be generated for asking the merchant to specify further details and information associated with the offers such as how the merchant would like the offer to be disseminated to the user (e.g., emails, mails, in-person delivery, or other means).

For example, the following queries may be generated and provided to the merchant for information for configuring one or more offers associated with the merchant:
What offer would you like to configure? Please specify offer details:
Do you want to associate a condition with the offer configured? Please specify the condition to be associated with the offer:
What other information do you want to specify for this offer?

The merchant may respond to the one or more queries generated in 820 by providing the information via a keyboard, touch pad, or similar mechanism provided by his device. For example, the merchant may provide the following information in response to the queries generated in 820:
Offers to be configured: 50% discount on selected cameras sold in all stores from Jan. 1, 2011-Mar. 1, 2011;
Condition associated with the offer to be configured: for users who have purchased at least one camera in the last year.

At step 825, responses for the one or more queries generated in 820 may be received from the merchant. The responses may be received by configuration module 184 via communication module 150.

At 830, one or more offers may be configured and generated for the merchant based on the responses received in 825. Each of the one or more offers generated in 830 has a corresponding condition associated with the offer. In one embodiment, the one or more offers may be configured and generated by configuration module 184 by generating a set of data from the responses received in 825. The set of data may include information identifying the offer details specified by the merchant, a condition associated with the offer, a start date associated with the offer, an expiration date associated with the offer, and other information provided by the merchant. The set of data may be written into a data structure (e.g., a data structure implemented in configuration module 184) that includes one or more data fields such as an “offer” field that specifies the offer details for an offer, a “condition” field that specifies the condition associated with the offer, a “start date” field indicating the start date for the offer to take effect, an “expiration date” field indicating the date that the offer expires, and other data fields.

In the above example, an offer is configured and generated by configuration module 184 by creating a set of data identifying the offer (50% discount on selected cameras sold in all stores from Jan. 1, 2011-Mar. 1, 2011) and the associated condition (for users who have purchased at least one camera in the last year), and the set of data is then written into the respective fields in the data structure.

At 840, the one or more offers configured in 830 and the corresponding condition associated with each offer configured in 830 may be stored and/output for the merchant. In one embodiment, the one or more offers configured in 830 and the corresponding condition associated with the one or more offers configured may be stored in database 160 of FIG. 1.

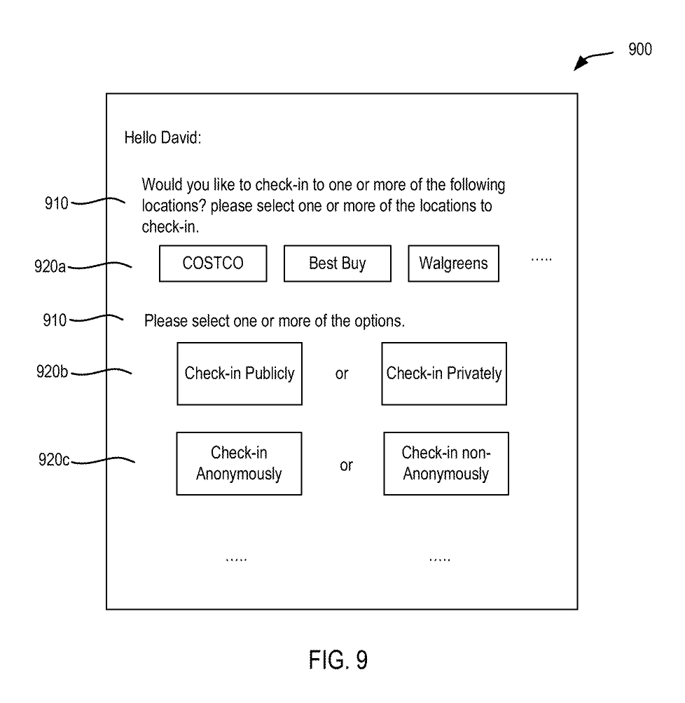

FIG. 9 is an example of a user interface 900 for a user to check-in to one or more commercial venues. Interface 900 may typically appear on a device display.

In one embodiment, interface 900 may includes one or more user instructions and/or queries 910 and one or more user selections 920a-920c. For example, user instructions 910 may instruct a user to select one or more commercial venues, select one or more check-in options, while user selections 920 provide one or more options for the user to choose from in response to user instructions 920. As illustrated in FIG. 9, the user is instructed to select one or more commercial venues from user selection 920a. In addition, the user is instructed to select either “public” check-in option or “private” check-in option from user selection 920b. Furthermore, the user is instructed to select “anonymous” check-in option or “non-anonymous” check-in option from user selection 920c. It will readily be appreciated by one of ordinary skill in the art that other user instructions and selections may be included in interface 900 and remain within the scope of embodiments claimed herein.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for providing an offer associated with a commercial venue to a user, comprising:
receiving a request associated with the user, the request including information identifying a commercial venue and a set of one or more check-in options;
determining an offer associated with the commercial venue identified in the request to be provided to the user based upon a set of contextual data associated with the user, wherein determining the offer to be provided to the user includes:
determining a set of one or more offers configured for the commercial venue, each offer configured for the commercial venue having a condition associated with the offer configured for the commercial venue; and
determining that the condition associated with a particular offer from the set of one or more offers configured for the commercial venue is satisfied by the contextual data associated with the user, wherein the particular offer from the set of one or more offers configured for the commercial venue is the offer determined to be provided to the user; and
generating a response message including the offer determined to be provided to the user.

2. The method of claim 1, wherein the commercial venue identified in the request is associated with a registered merchant.

3. The method of claim 1, wherein the set of contextual data associated with the user comprises information identifying past shopping history of the user, an email address of the user, one or more friends of the user, one or more locations that the user have visited, and other information associated with the user.

4. The method of claim 1, wherein the set of one or more check-in options includes a pubic check-in option, a private check-in option, an anonymous check-in option, a non-anonymous check-in option, or a combination thereof.

5. The method of claim 1, further comprising generating one or more queries for the user.

6. The method of claim 5, wherein generating one or more queries comprises generating a query for asking the user to select at least one commercial venue from a list of one or more commercial venues identified in the query, wherein the selected at least one commercial venue is identified in the request received.

7. The method of claim 5, wherein generating one or more queries comprises generating a query for asking the user to select one of a pubic check-in option or a private check-in option, wherein selecting the public check-in option by the user causes one or more locations associated with the user to be broadcasted to a social graph associated with the user, and wherein selecting the private check-in option by the user causes one or more locations associated with the user to be kept confidential.

8. The method of claim 5, wherein generating one or more queries comprises generating a query for asking the user to select one of an anonymous check-in option or a non-anonymous check-in option for the user to check-in to the commercial venue, wherein selecting the non-anonymous check-in option by the user causes the set of contextual data associated with the use to be included in the request received, and wherein selecting the anonymous check-in option by the user causes the set of contextual data associated with the use to be excluded from the request received.

9. The method of claim 1, further comprising receiving information identifying one or more locations associated with the user.

10. The method of claim 9, wherein the one or more locations associated with the user includes a current location of the user and a list of one or more commercial venues within close proximity to the current location of the user.

11. The method of claim 1, wherein the request includes the set of contextual data associated with the user.

12. A computer-readable storage medium storing a plurality of instructions for controlling a processor to provide an offer associated with a merchant to a user, the plurality of instructions comprising:
instructions that cause the processor to receive a configuration request associated with the merchant;
instructions that causes the processor to generate a set of one or more offers associated with the merchant responsive to the configuration request, each offer generated having a condition associated with the offer;
instructions that cause the processor to receive a check-in request associated with the user, the check-in request identifying a commercial venue associated with the merchant and a set of one or more check-in options, wherein the one or more check-in options are selected by the user in response to one or more queries;
instructions that cause the processor to determine at least one offer from the set of one or more offers associated with the merchant to be provided to the user based upon a set of contextual data associated with the user.

13. The computer-readable storage medium of claim 12, wherein the set of one or more check-in options includes a private check-in option, a public check-in option, an anonymous check-in option, a non-anonymous check-in option, or a combination thereof.

14. The computer-readable storage medium of claim 12, wherein the instructions that cause the processor to determine at least one offer from the set of one or more offers associated with the merchant to be provided to the user include instructions that causes the processor to determine that the condition associates with the at least one offer from the set of one or more offers associated with the merchant is satisfied by the contextual data associated with the user.

15. The computer-readable storage medium of claim 12, wherein the plurality of instructions further comprises instructions that cause the processor to generate a query for asking the user to select one of an anonymous check-in option or a non-anonymous check-in option, wherein selecting the non-anonymous check-in option by the user causes the set of contextual data associated with the use to be included in the check-in request received, and wherein selecting the anonymous check-in option by the user causes the set of contextual data associated with the use to be excluded from the check-in request received.

16. The computer-readable storage medium of claim 12, wherein the plurality of instructions further comprises instructions that cause the processor to generate a query for asking the user to select one of a pubic check-in option or a private check-in option, wherein selecting the public check-in option by the user causes one or more locations associated with the user to be broadcasted to a social graph associated with the user, and wherein selecting the private check-in option by the user causes one or more locations associated with the user to be kept confidential.

17. A system for a user to check-in to a commercial venue comprising:
a memory; and
a processor coupled to the memory;
wherein the processor is configured to:
receive information identifying one or more locations associated with the user, the one or more locations including a current location of the user and a list of one or more commercial venues within close proximity to the current location of the user;
generate one or more queries for asking the user to check-in to the list of one or more commercial venues responsive to the information received;
receive a check-in request associated with the user, the check-in request identifying a commercial venue from the list of one or more commercial venues and a set of one or more check-in options;
determine if the commercial venue identified in the request is associated with a registered merchant;
determine an offer associated with the commercial venue identified in the check-in request to be provided to the user based upon a set of contextual data associated with the user.

18. The system of claim 17, wherein generating one or more queries includes generating a query for asking the user to select one of an anonymous check-in option or a non-anonymous check-in option, wherein selecting the non-anonymous check-in option by the user causes the set of contextual data associated with the use to be included in the request received, and wherein selecting the anonymous check-in option by the user causes the set of contextual data associated with the use to be excluded from the request received.

19. The system of claim 17, wherein generating one or more queries includes generating generate a query for asking the user to select one of a pubic check-in option or a private check-in option, wherein selecting the public check-in option by the user causes one or more locations associated with the user to be broadcasted to a social graph associated with the user, and wherein selecting the private check-in option by the user causes one or more locations associated with the user to be kept confidential

20. The system of claim 17, wherein the set of one or more check-in options includes a pubic check-in option, a private check-in option, an anonymous check-in option, a non-anonymous check-in option, or a combination thereof.
